(19) United States
(12) Patent Application Publication
(10) Pub. No.: US 2024/0367162 A1
(43) Pub. Date: Nov. 7, 2024

(54) HYBRID MOBILE MICROFLUIDIC METHOD AND APPARATUS

(71) Applicant: LabSmith, Inc., Livermore, CA (US)

(72) Inventors: Eric B. Cummings, Livermore, CA (US); Kirsten K. Pace, Livermore, CA (US)

(73) Assignee: LabSmith, Inc., Livermore, CA (US)

(21) Appl. No.: 18/143,598

(22) Filed: May 4, 2023

Related U.S. Application Data
(60) Provisional application No. 63/328,125, filed on Apr. 6, 2022.

(51) Int. Cl. B01L 3/02

(52) U.S. Cl. CPC B01L 3/0237; B01L 3/0275; B01L 2400/043

(57) ABSTRACT

An objective according to some embodiments is to minimize the consumable materials needed to conduct a chemical or biological process. An objective according to other embodiments is to take full advantage of capabilities offered by a motion stage. An apparatus may include a motorized traverse, a flow controller, a tip-mount traverse, and a tip, and may also include a motion of a tip past an influencer or a motion past an actuatee. An apparatus may include a floss, a floss-advancing reel, a floss wetter, and a tip cleaning region. An apparatus may include a motor, a rotor having an eccentric bearing hole and taper that leads to the bearing hole, and a vibration damping element that acts on a surface region of a tip inserted into the eccentric hole.

### CROSS-REFERENCES TO RELATED APPLICATIONS

This application claims priority to U.S. Provisional Application No. 63/328,125, filed Apr. 6, 2022, the entire contents of which are hereby incorporated by reference for all purposes.

### BACKGROUND

Microfluidics and conventional pipettor-based robotics are well known techniques for processing and creating chemical and biological products. Some implementations of these methods comprise a consumable element, e.g., a microfluidic chip or tubing, vials, reactors, test tubes, pipette tips, etc. as well known in the art.

### SUMMARY

An objective according to some embodiments is to minimize the consumable materials needed to conduct a chemical or biological process. An objective according to other embodiments is to take full advantage of capabilities offered by a motion stage.

In accordance with an embodiment, an apparatus includes a motorized traverse, a flow controller, a tip-mount traverse, and a tip, and also includes a motion of a tip past an influencer.

In an embodiment, the influencer is a non-uniform magnetic field.

In another embodiment, the influencer is an absorbent material.

In yet another embodiment, the influencer is a thermal interface material in communication with a thermal source. The thermal source may be a Peltier module.

In accordance with another embodiment, an apparatus includes a motorized traverse, flow controller, a tip mount traverse, and a tip including a motion past an actuatee.

In an embodiment, the actuatee is the tip-mount traverse.

In another embodiment, the actuatee is a plug retainer in a station that applies and removes a tip plug.

In accordance with another embodiment, an apparatus includes a floss, a floss-advancing reel, a floss wetter, and a tip cleaning region.

In an embodiment, the apparatus also includes a traverse motion profile that wipes the surface of the tip across a floss.

In accordance with yet another embodiment, an apparatus includes a motor, a rotor having an eccentric bearing hole and taper that leads to the bearing hole, and a vibration damping element that acts on a surface region of a tip inserted into the eccentric hole.

### BRIEF DESCRIPTION OF THE DRAWINGS

FIG. 1 shows a schematic diagram of a mobile microfluidic system according to an embodiment of the present invention.

FIGS. 2A and 2B show schematic diagrams of moving-tip interactions according to an embodiment of the present invention.

FIGS. 2C and 2D show schematic diagram of moving-tip interactions according to an embodiment of the present invention.

FIGS. 3A and 3B show schematic diagrams of instantaneous elastic tip distortions in accordance with some embodiments of the present invention.

FIGS. 3C, 3D, and 3E show schematic diagrams of elastic tip distortions in according to alternative embodiments of the present invention.

FIGS. 4A-4D show sequential schematic diagrams according to a fluid infusion embodiment of the present invention.

FIGS. 4E-4G show schematic diagrams of a fluid infusion according to alternative embodiments of the present invention.

FIGS. 5A-5F show schematic diagrams of a tip mount attachment/detachment mechanism according to an embodiment of the present invention.

FIG. 6A shows a schematic diagram of a flow controller according to some embodiments of the present invention.

FIGS. 6B-6F show schematic diagrams of the pump/valve plumbing of the flow controller in different states according to some embodiments of the present invention.

FIG. 7A-7D show schematic diagrams of a cleaning station embodiment according to some embodiments of the present invention.

FIGS. 8A and 8B show schematic diagram of a vortexer/normalizer according to some embodiments of the present invention.

FIG. 8C show a schematic diagram of a vortexer/normalizer according to an alternative embodiment of the present invention.

FIGS. 9A, 9B, and 9D show schematic diagrams of a thermally controlled reactor station according to some embodiments of the present invention.

FIGS. 9C and 9E show schematic diagrams of a thermally controlled reactor station according to an alternative embodiment of the present invention.

FIGS. 10A and 10B show schematic diagrams of a magnetic separator according to some embodiments of the present invention.

FIGS. 11A-11D show schematic diagrams of a tip sealer/un-sealer according to some embodiments of the present invention.

FIGS. 12A-12D show schematic diagrams of a plug station according to some embodiments of the present invention.

FIG. 13 shows schematic diagram of a workstation for tip, vial, capping, and storage operations according to some embodiments of the present invention.

FIGS. 14A and 14B show schematic diagrams of a freezer or ultra-freezer apparatus according to some embodiments of the present invention.

### DETAILED DESCRIPTION

As used herein, a ‘process’ generically refers to at least one step comprising a physical, chemical, or biological manipulation. Physical manipulations may comprise but are not limited to aliquoting, diluting, distilling, fractionating, pipetting, washing, mixing, diffusing, convecting, vortexing, osmosing, heating, cooling, ultrasonic agitating or cavitating, mechanically interacting, magnetically interacting, electrostatically interacting, optically interacting, electrophoresis, electroosmosing, dielectrophoresis, electroporating, patch-clamping, centrifuging, etc. Chemical manipulations may comprise but are not limited to reacting, electrochemically interacting, charge transferring, changing of an energy state, titrating, buffering, desalting, dialyzing, labeling, separating, etc. Separations may employ chromatography, electrochromatography, isotachophoresis, etc. Biological interactions may comprise but are not limited to incubating, in vitro synthesizing (IVT), polymerase chain reacting (PCR), vaccinia tagging, tagging, lysing, transfecting, etc.

A process herein may be a chain of steps completed serially, in parallel, or in an arbitrary combination of parallel and serial steps.

As used herein ‘enchamber’ may mean physically to contain. Enchambering elements may comprise a barrier to diffusion, evaporation, convection, reaction, and electric, magnetic, thermal, optical fields, etc.

As used herein ‘tip’ may refer to an enchambering vessel having at least one port, such as a disposable pipette tip. On a two-port tip, the ‘actuator port’ may refer to an opening of a tip designed to seal to a pipettor, through which hydraulic or pneumatic fluids pass bidirectionally, and the ‘reagent port’ may refer to an opening of the tip through which reagent and reactant fluids pass bidirectionally.

It is well known in the field to use a tip to transfer liquids to and from vials and other chambers via mechanical motion during a process. It is also known in the art to use microfluidic channels to enchamber processes and route liquids via fluid motion. Some embodiments of the present invention comprise a hybrid mobile microfluidic circuit which may employ mechanical motion as well as fluid motion and process enchamberment.

As used herein a ‘tip station’ may comprise the apparatus at a site where a tip may be located for an operation such as storage, thermal cycling, elution, infusion, separation, vortexing, missing, centrifugation, refrigeration, freezing, etc.

In some embodiments of the present invention, the mobile microfluidic device or tip comprises a single-port, a two-port, or a multiple port chamber. In some embodiments, the microfluidic device comprises a plurality of chambers. In some embodiments, at least one such chamber is connected fluidically to a second such chamber. Some embodiments further comprise a filter element, e.g., a barrier filter as known in the art. Some embodiments further comprise a surface modification. Some embodiments comprise at least one surface modification on one or more of: an interior surface, an exterior surface, a chamber surface, a partial chamber surface.

In some embodiments of the present invention, the mobile microfluidic device may comprise a disposable tip as known in the art. In some embodiments, the tip may further comprise a barrier filter as known in the art.

Advantages of a hybrid mobile microfluidic device may be:
alleviating problems, such as sample retention, cost, and complexity of fluid routing to the microfluidic chamber;
alleviating the problems of micromixing on a static microfluidic chip;
facilitating modular operation stations whose actions can be programmatically changed rather than prescribed by fixed design;
minimizing the consumable cost of the microfluidic chip; and
reducing the complexity, risk, and quantity of ancillary equipment to control a process.

Disadvantages may be:
an increased risk of cross-contamination; and
uncertainty in gas/liquid interface position with a chamber.

Cross contamination may be alleviated by a ‘tip cleaning’ method and apparatus according to some embodiments of the present invention.

The uncertainty in gas/liquid interface position may be alleviated by a ‘plug-centering’ or ‘normalization’ method and apparatus according to some embodiments of the present invention.

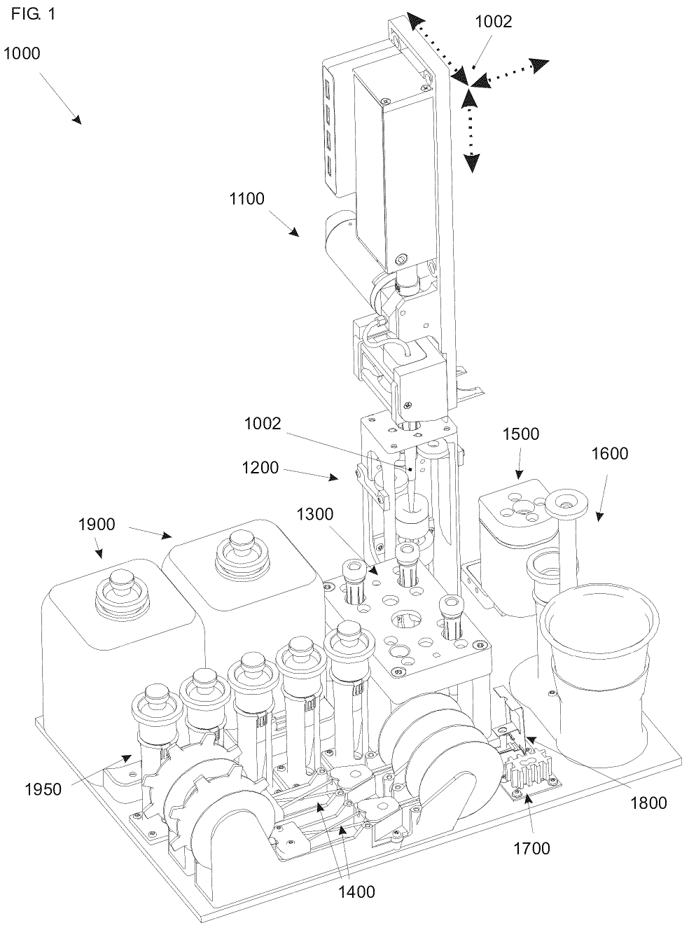

FIG. 1 shows an embodiment 1000 of a mobile microfluidic system comprising a traverse (1002, unshown) which provides motion of a flow controller/tip mount 1100 that is positioning pipette tip 1002 in a vortexer/normalization station 1200. The system further comprises a capping/storage station 1300, a plurality of cleaning stations 1400 a thermocycler station 1500, a magnetic particle purifier station 1600, a tip sealer/un-sealer station 1700, a tip plug pyrolizer station 1800, a plurality of ultra-freezer stations 1900, and a reagent station 1950. The traverse engages with different stations substantially through motion of the traverse-mounted flow controller. Traverse-mounted tool features provide for tip mounting, capping, uncapping, reagent vial loading and unloading, actuating passive mechanisms, and actuating tip interactions with external fields and objects.

While the language and imagery employed in this disclosure depict a pipette tip as the mobile microfluidic element, this depiction is not intended to be limiting. Other embodiments of mobile microfluidic elements may comprise a vessel having more than two ports, a tube, a capillary, a microfluidic chip, a chamber, a multiple-port fluidic circuit.

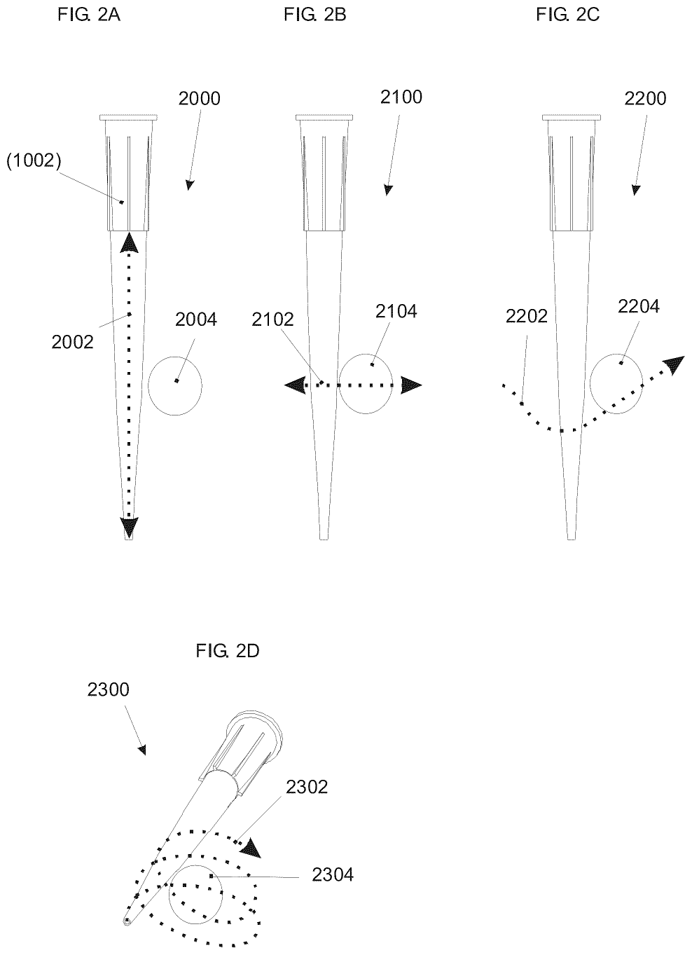

FIG. 2 shows embodiments of moving-tip interactions in accordance with some embodiments of the present invention. FIG. 2A contains a view 2000 of axial motion 2002 of a tip (1002) relative to 2004, an external sensor, object, or field herein called an ‘influencer,’ or a motion-actuated mechanism herein called an ‘actuatee.’ This motion is well known in the art for pipetting, wherein 2004 is an annular object such as a vial, a tip rack, a tube, etc. In some embodiments of the present invention, an influencer is one or more of a thermal-interface, a cleaning surface, a vibration damper, a bearing, a magnet, a field, an ultrasonic transducer, an electric field, a magnetic field, an electromagnetic field, a laser, etc. A sensor embodiment of 2004 may comprise a liquid-level/meniscus sensor, turbidity sensor, light-scattering sensor, absorption sensor, fluorescence sensor, nonlinear optical interaction sensor, capacitive sensor, etc. Some embodiments of motion-actuated mechanisms may comprise a ratchet, a ‘click-pen’ mechanism, a key-hole slot, switch, potentiometer, lever, slide, piston, mass, etc.

FIG. 2B contains a view 2100 of transverse motion 2102 of a tip past a sensor, influencer, or actuatee 2104. In conventional pipetting, translational motion of a tip may only be utilized to position a tip for pipetting, storing, or discarding.

FIG. 2C contains a view 2200 of coordinated axial and transverse (two-dimensional) motion past a sensor, influencer, or actuatee. Some embodiments in accordance with the present invention comprise a coordinated motion, e.g., to advance a sprocket, turn a wheel, wipe a tip on a cleaning surface, etc.

FIG. 2D contains a view 2300 of a coordinated three-dimensional motion past a sensor, influencer, or actuatee 2304. Some embodiments in accordance with the present invention comprise a three-dimensional coordinated motion around a magnet, etc.

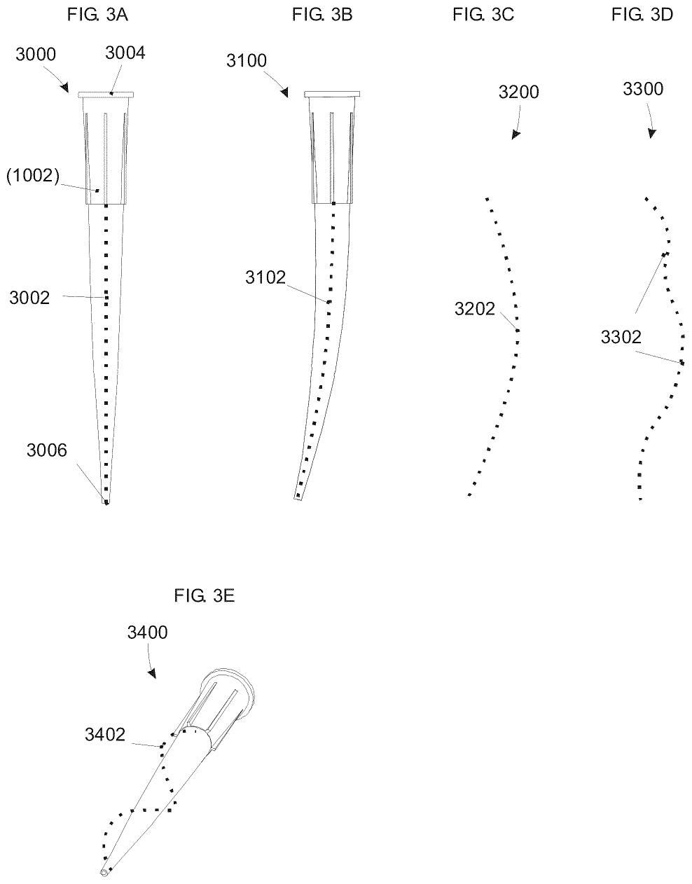

FIG. 3 shows views of instantaneous elastic tip distortions in accordance with some embodiments of the present invention. These tip distortions may comprise static distortions, dynamic distortions, linearly polarized vibrations, circularly polarized vibrations, elliptically polarized vibrations, standing waves, traveling waves, surface vibrations, longitudinal vibrations, transverse vibrations, surface acoustic waves, as known in the art. A distortion may be induced by external traction or normal force, pressure, stress, instability, buckling, centrifugal force, applied thermal, mechanical, vibrational, electrical, magnetic, electrostrictive, magnetostrictive field, etc., as known in the art. Furthermore, a distorter may be inserted into, or removed from a tip, or manufactured into a tip body or surface or programmed via one or more of: tip material type and distribution, tip temperature, tip thickness, varicose patterning, bellows geometries, helices, ridges, valleys, rings, notches, and ratchet structures.

Intentional tip distortions may be unknown in conventional pipetting.

FIG. 3A shows a view 3000 of a substantially un-distorted tip having a central bore-line 3002 that is straight. As used herein the tip opening at 3004 is the actuator port and the tip opening 3006 is the reagent port.

FIG. 3B shows a view 3100 of a tip with a curved central bore-line distortion 3102 having a maximal displacement at the reagent port. Some embodiments of vortexer stations according to the present invention may use such a distortion.

FIG. 3C shows a view 3200 of a central bore-line distortion 3202 having a maximal displacement at a point away from either port. Some embodiments of tip centrifugal stations according to the present invention may use such a distortion.

FIG. 3D shows a view 3300 of a two-dimensional central bore-line distortion featuring a plurality of lobes. Some embodiments of processing stations may employ such a distortion to establish at least one fluid plug position.

FIG. 3E shows a view 3400 of a three-dimensional central bore-line distortion 3402. In some embodiments helical distortions may be used to induce axial motion.

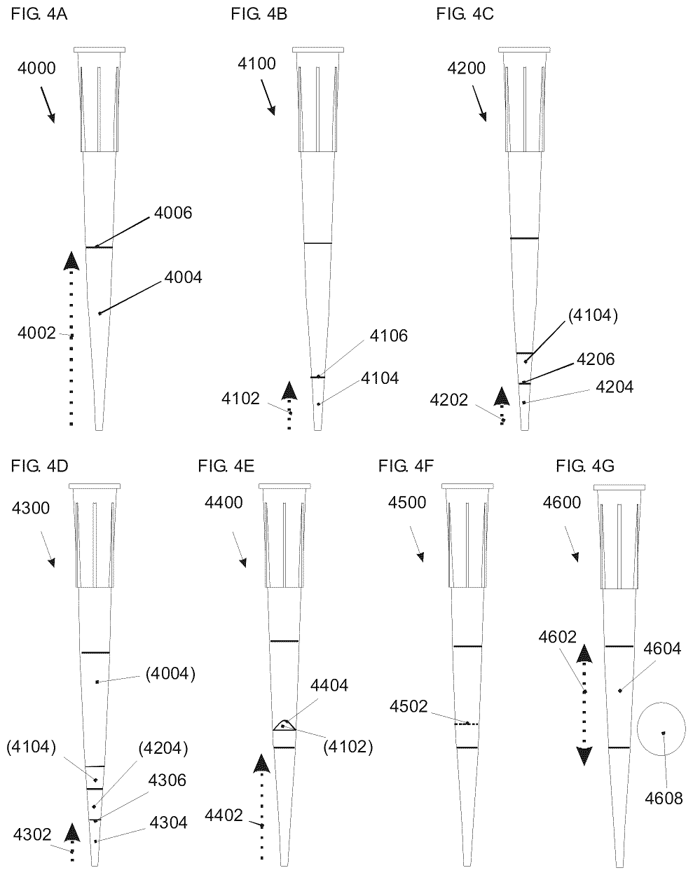

Axial fluid motion within the tip may be combined with translational motion and distortional motion to achieve a desired function. FIG. 4 shows sequential views according to a fluid infusion embodiment of the present invention. FIG. 4A shows view 4000 of a first infusion step, employing motion 4002 of a first liquid 4004 to establish a first meniscus position 4006. FIG. 4B shows a view 4100 of a second infusion step, employing motion 4102 to draw a first ‘buffer’ fluid 4102 that is immiscible with the first fluid to establish a second meniscus 4106. In some embodiments the buffer fluid may comprise a gas, an oil, a perfluorinated oil, etc., as known in the art. In some embodiments, the buffer fluid is also immiscible with a second liquid. Gases, such as air, nitrogen, argon, carbon dioxide, steam, ethylene, methane, propane, hydrogen, helium, etc. are embodiments of buffer fluids.

FIG. 4C shows a view 4200 of a third infusion motion 4202 of a second liquid 4204 to establish a third meniscus 4206, entrapping the fluid 4104. An advantage of employing the immiscible phase 4104 between 4204 and 4004 may be eliminating substantial cross contamination of the second liquid in the container from which 4204 was drawn.

FIG. 4D shows a view 4300 of a motion 4302 that draws in a second buffer fluid 4304. In some embodiments, the second buffer fluid is the same as the first. Following this step, the tip and its contents may be translated to a processing or cleaning station without concern for pendant drops or wicking out of the reagent port. However, the immiscible phase may prevent the first and second liquids from mixing.

Some embodiments of infusion comprise a larger infusion of the second buffer fluid, shown in the view 4400 of FIG. 4E. Motion 4402 raises the entrapped plug 4102 to a location of the tip wherein the meniscus 4404 becomes unstable. If there is a suitable density difference between the buffer fluid and liquid, the buffer fluid may pass as a droplet or bubble through the liquid. In some embodiments, this multi-phase transport may be enhanced and the effects of surface tension overcome by transverse impulses applied to the tip, vibrations, oscillatory flow, etc.

FIG. 4F shows a view 4500 wherein the buffer fluid has escaped its entrapment to allow the first and second liquids to mix along diffuse interface 4502.

FIG. 4G shows a view 4600 wherein an axial motion 4602 is produced by a flow controller while a liquid plug 4604 interacts with an external sensor or influencer. Some embodiments may coordinate a tip translation with the fluid motion.

### Tip Attachment/Detachment

An embodiment of the present invention may comprise apparatus to detach a tip. An embodiment of the present invention may comprise apparatus to attach a tip. Some embodiments may comprise apparatus that may be used both to attach and to detach a tip.

It is common in the art to attach a tip by pressing a conical mount into a conical lead-in section of a tip, the tip seal being made substantially by a normal force between the mount and lead-in section via elastic preload, and the attachment achieved by friction produced by this preload. It is common to employ a motion robot for this purpose. It is common in the art to detach a tip by pressing axially along an extent of the top rim of the tip.

It is common in the art to attach a tip by rotating mating thread portions on a tip and a mount, e.g., a ‘luer’ lock as known in the art. Such an attachment may use the same action (a relative rotation) to mount or dismount.

Some embodiments of the present invention comprise one or more of a ‘tip cap,’ a ‘lock,’ a ‘pressure interface,’ a ‘pressure interface seal’, a ‘tip seal’, a ‘mounting interface,’ a ‘lock detente’, an ‘alignment pin.’

### Tip Cap

Some embodiments of a tip cap may comprise a rigid, or semi-rigid, rubber, elastic, plastic, metal, or composite mount having an opening port to pass fluid between a pressure interface and tip.

To effect a mounting restraint force, some embodiments of tip caps comprise one or more of: a frictional bearing surface, a normal-force bearing surface, a partial thread, a clip, a ratcheting mechanism, a pneumatic mechanism, a hydraulic mechanism.

To effect a seal between the tip cap and tip, some embodiments of tip caps comprise a conical cylindrical outer surface. Some such embodiments seal to the tip in part via an elastically generated normal force. Some tip-cap embodiments comprise at least one outer groove to accommodate an o-ring to effect or enhance a seal. Some embodiments comprise at least one outer, substantially circumferential rib. Some embodiments may comprise a pneumatically or hydraulically inflated/deflated seal.

Some embodiments of tip caps may comprise an element to prevent transport of material between the tip and surroundings when the pressure interface is detached. Some embodiments of tip caps comprise an elastic septum as known in the art. Some embodiments of tip caps, may further comprise a valve. Some embodiments of a tip cap valve may be in the open state when the cap is engaged with a pressure interface. Some embodiments of tip caps may further comprise a filter, such as a barrier filter.

Some embodiments of tip caps may comprise an element to attach to a pressure interface. Some such embodiments may comprise one or more of: a frictional bearing surface, a normal bearing surface, a partial thread, a locking mechanism, a hydraulic mechanism, a pneumatic mechanism.

Some embodiments of tip caps may comprise an element to attach to a pressure interface. Some such embodiments may comprise one or more of: a normal-force preload, an o-ring seal, an elastic septum, a swage, a circumferential ring, a circumferential cavity.

### Lock

As used herein, a ‘state’ may be a position, orientation, or mechanical configuration. Some embodiments of tip caps and locks may comprise a mechanism that mechanically resists detachment in at least one state. Some such embodiments may further comprise at least one state, or configuration that does not mechanically resist detachment. Some embodiments of tip cap locks may comprise an element that overcomes a bearing friction force at a state or range of states between the first and second state.

Some embodiments of locks may further comprise one or more additional states. In some embodiments, an additional state may comprise a fluidic configuration such as one or more of the following: a pressure-interface vented state, a pressure-interface unvented state, a tip-vented state, a tip-unvented state. An additional state may comprise a mechanical configuration such as a rotation-resisting state, a rotation enabling state, a partial detachment state, a mechanically unconstrained state, a mechanically relaxed state, a mechanically rigid state.

Some embodiments of locks may comprise one or more of: a ramp, a slot, a keyhole slot, a partial thread, a slide, a ratchet, a clip, a clamp, a pneumatic mechanism, a hydraulic mechanism.

### Détente

Some embodiments comprise at least one détente that relaxes toward a state. Some embodiments of détentes employ one or more of: an elastic interaction, a flexure, a magnetic interaction, an electrostatic interaction, a ratchet.

### Pressure Interface

Some embodiments of pressure interfaces comprise an element that mates to a complementary seal element on a tip cap. Some embodiments further comprise one or more of an o-ring, a hydraulic or pneumatic actuated seal, a mechanical-actuated mount. Some embodiments comprise at least one sliding or rotating surface in mechanical communication with one or more of: a mount, a lock, a cap, a tip, a tip station.

### Alignment Feature

Some embodiments of locks or pressure interfaces according to the present invention may further comprise one or more alignment features. Some embodiments employ such a feature for one or more of: to establish a known state from an initially uncertain state, to reduce an actuation force on a tip, to establish an alignment between a tip and tip station. Some such embodiments comprise a pin, a cone, a ball, a partial thread, a concavity, a convexity, or a mating geometry thereof. Some embodiments may comprise a mating geometry to an alignment feature on a tip station.

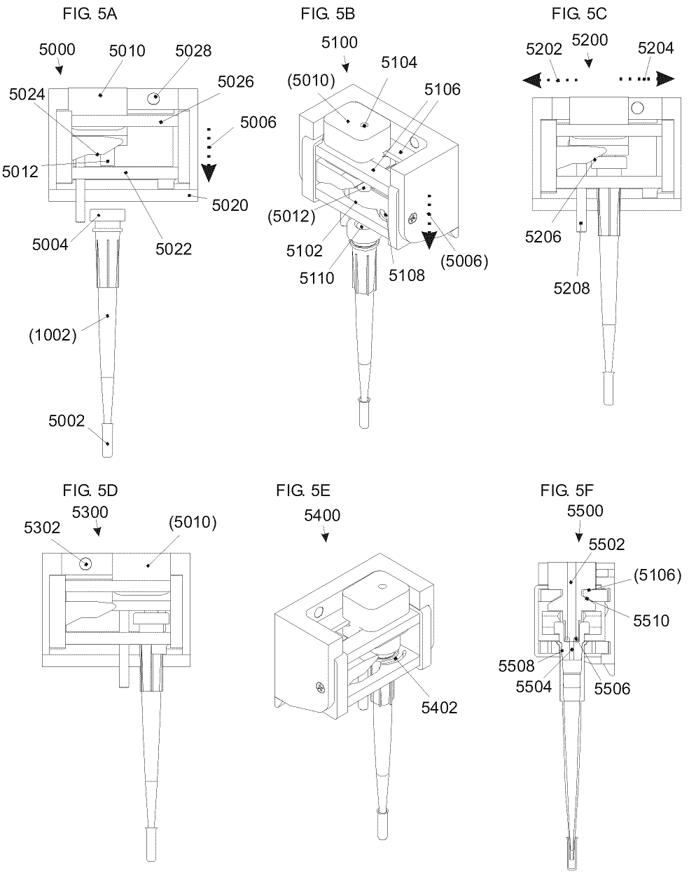

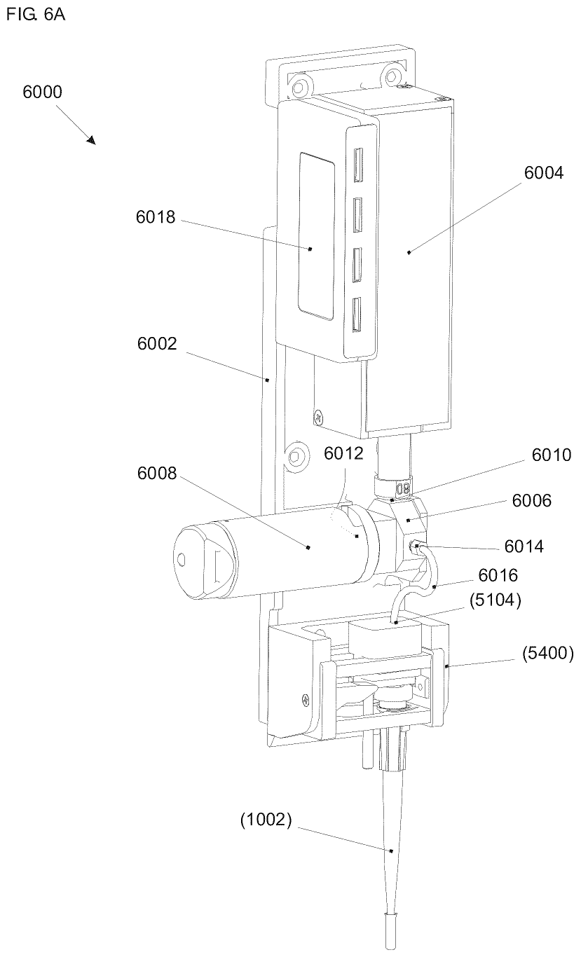

FIG. 5 shows views of a tip mount attachment/detachment mechanism according to some embodiments. Element 5002 on tip 1002 is a plug, that is used in some embodiments to provide one or more of: a pressure seal, a contamination barrier, an abrasion protector, a tip end protector. Element 5004 is an embodiment of a tip cap. FIG. 5A shows a side view 5000 of the mechanism comprising a sliding mount 5010 containing a pressure interface 5012 designed to seal breakably with a mating feature in 5004. Element 5020 is the traverse structure comprising a keyhole rail that allows tip and tip cap to be inserted in this mount position by undergoing a motion 5006 until the top of 5004 contacts the variable ramp 5024. In some embodiments, motion 5006 is produced by a motorized traverse. Element 5026 is a rail on which the mount 5010 can slide. In some embodiments, element 5028 comprises a magnet, disposed to attract a second magnet mounted on 5010 such that a component of magnetic force applies along the traverse to effect a magnetic détente at the end of travel.

FIG. 5B shows a view 5100 of the same mechanism arrangement in FIG. 5A. From this angle the keyhole slot 5102 is visible. Element 5104 is a port that connects to a flow controller. Surfaces 5106 are bearing surfaces for the traversing mount 5010. Element 5108 is a mechanical détente in some embodiments. The motion 5006 engages port 5110 with the pressure interface.

FIG. 5C shows a view 5200 of the mechanism in a location where the tip is partly engaged. A stage motion 5202 will fully engage the tip in the mount. A motion 5204 will disengage the tip from the keyhole, then a vertical motion will disengage the tip and cap from the mount. Bearing of the variable ramp on the cap surface at 5206 may help to overcome the friction of disengagement. Element 5208 may be a substantially rigid element used to relieve side loads that would otherwise be transferred to the tip. Element 5208 may further provide a rigid and accurate engagement location with a station.

FIG. 5D shows a side view of the mechanism with the mount 5010 in the tip-locked position. In this position a magnet 5302 that produces a détente force toward the unlocked position is uncovered. FIG. 5E shows an angled view of the same mechanism state. The tip cap is engaged in the mechanical détente at 5402.

FIG. 5F shows a cutaway view of an embodiment of a locked mechanism showing the internal structure. Port 5502 communicates actuation pressure from a flow controller, through tip cap port 5504 into the tip. Element 5506 is an embodiment of a pressure seal, such as an o-ring, gasket, or radial compression. Element 5508 is an embodiment of a pressure seal between the tip cap and tip. Element 5510 is a second bearing surface opposite to 5106 over which the mount 5010 slides.

### Flow Controller

Conventional pipettors may comprise a positive displacement pump, such as a piston pump or syringe pump to control infusion and elution, herein called ‘flow control.’ Embodiments of the present invention comprise a flow controller comprising one or more of: a pump, a valve, a sensor. Some embodiments of a pump according to the present invention comprise a positive-displacement pump, a piston pump, a syringe pump, a gear pump, a diaphragm pump, an impeller pump, an ultrasonic pump, etc. Some embodiments of sensors comprise one or more of a pressure sensor, a flow sensor, a meniscus sensor, a bubble sensor, an absorption sensor, a reflection sensor, a scattering sensor. Some embodiments of valves employ pressure, mechanical, magnetic, solenoidal, motor actuation, or thermal actuation. Some valve embodiments comprise a check valve, an on-off valve, a metering valve, a needle valve, a rotary valve, a swept-volume valve. Some valves comprise a three-port valve having one common position and two ports as known in the art. Some valves comprise a four-port valve as known in the art. Some valves comprise a six-port valve as known in the art.

In some embodiments the role of a flow-controller valve is to allow a finite-volume piston pump to refill or empty so it can elute or infuse into a pipette tip a volume that exceeds the volume of the piston's cylinder. This may confer the advantage of high-accuracy microdosing into comparatively large tip volumes without a loss of accuracy or the need to dilute.

In some flow-controller embodiments one or more of a flow-controller valve or pump is used in concert with a feedback sensor. In some embodiments a feedback sensor is used to meter a displaced volume. In some embodiments, a feedback sensor is used to establish a known meniscus position. Some embodiments of flow-controllers rely solely on positive displacement to establish a known meniscus position.

Some embodiments of the present invention mount flow-controller hardware in the reference-frame of the pressure interface. Some embodiments mount the flow-controller hardware in the reference frame of a traverse stage and connect via a flexible conduit to the pressure interface. Some embodiments mount in a substantially stationary reference frame and connect to the pressure interface via a longer flexible conduit.

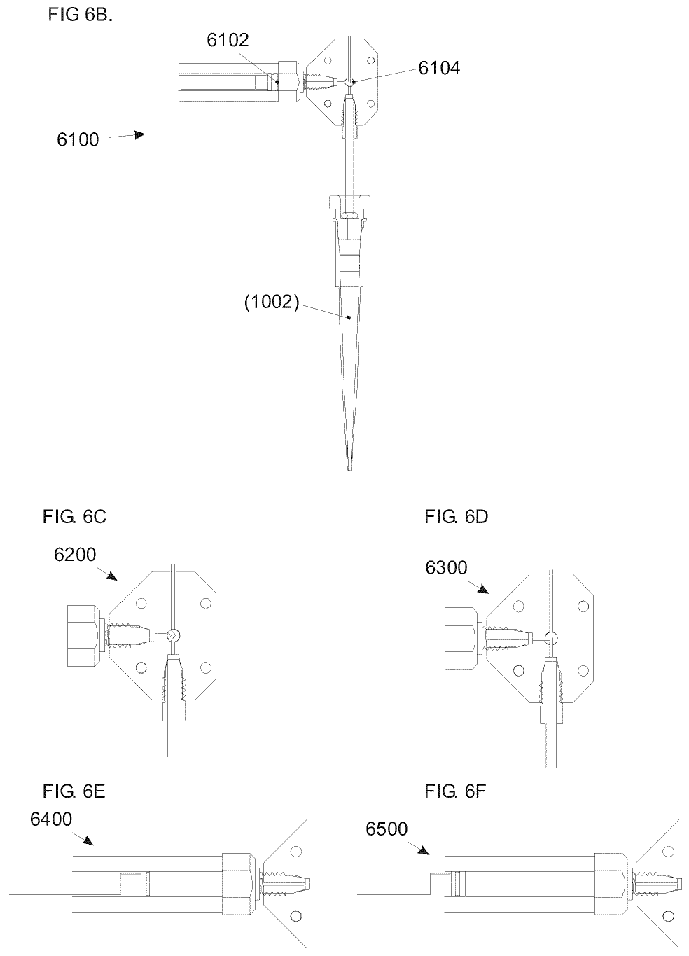

FIG. 6A shows an embodiment 6000 of a flow controller according to the present invention. Element 6002 is a frame that mounts to a traverse head. In this embodiment, element 6004 is a syringe pump, element 6006 is a valve body, and 6008 is a motor actuator. The exit of the syringe pump enters one port of the valve at 6010. A second port of the valve (not visible) 6012 is open to air or to a buffer fluid reservoir. A third port of the valve 6014 connects to the tip mount depicted in 5000 via a flexible tube 6016. Element 6018 comprises an electronic controller that can employ pressure, syringe position, and flow feedback to control the valve and in some embodiments the syringe motion.

FIGS. 6B-6F show schematic views of the pump/valve plumbing of the flow controller in different states. View 6100 shows the syringe plunger/pump piston 6102 substantially at the end of its travel and valve rotor 6104 rotated to connect the pump port to the vent/buffer gas/buffer fluid port. View 6200 shows the valve rotor rotated to the position where no ports are connected. View 6300 shows the valve rotor in the position that connects the pump to the output of the flow controller. View 6400 shows the syringe plunger/pump piston in an intermediate position and view 6500 shows the syringe plunger in a starting position. The permutations of valve position and plunger motion provide for unlimited dispensing and drawing via sequences of valve motions and syringe fills or empties as known in the art. Some embodiments further comprise a pressure sensor. Some embodiments further comprise a flow sensor. Some embodiments measure, and in some embodiments, control doses via a weight sensor. Some such measurements are made on a vial. Some measurements are made via subtracting a first weight from a second weight.

### Tip Cleaning Station

Tip cleaning may be important for preventing cross contamination of reagents during infusions. In some embodiments, a liquid infusion may be followed by a small infusion of a buffer fluid such as air, an inert gas, carbon dioxide, reactant gas, etc. to break contact of the liquid plug from any residual pendant or stuck drops on the tip exterior.

Some embodiments of the present invention wipe/abrade/press the contaminated end of the tip on or through an absorbent surface. In some embodiments the surface is pre-wetted with a solvent, e.g., water, an alcohol, an organic solvent, or a mixture, a detergent solution, or cleaning agent. In some embodiments, the cleaning procedure iterates. In some embodiments, the solvent type and saturation of absorbent surface is altered from one iteration to the next. In some embodiments, the final iteration or iterations may produce a substantially dry surface.

In some embodiments, uncontaminated absorbent surface is used for each cleaning iteration. In some embodiments, this is achieved by wiping on a different zone of an absorbent sheet. In some embodiments this is achieved by wiping on a ‘tape’ or ‘floss’ that is advanced during or in between iterations.

### Sheets, Tapes, and Flosses

As used herein, a ‘sheet’ may be a flexible object, having a length and width that is much greater than a thickness. As used herein, a ‘tape’ may be a flexible object having a length that is much greater than a width, and a width that is greater than a thickness. As used herein, a ‘floss’ may be a flexible object having a length that is much greater than a width and a width and thickness that are comparable. Some embodiments of sheets may be random or aligned arrangements of fibers, papers, tissues, fabrics, gauzes, etc. Tapes may be strips of random or aligned fibers, strips of paper, strips of woven fibers, etc. Some embodiments of flosses may be yarns, threads, collections of random, aligned, or twisted fibers, braided or woven fibers or threads, etc. The composition of a sheet, tape, or floss may be materials having a desired physical or chemical characteristic, such as nap, wettability, hydrophobicity, hydrophilicity, abrasiveness, etc. Some tapes or flosses according to the present invention may comprise a mixture of component fibers, binders, surface modifiers, gels, surfactants, oils, greases, pastes, particles, powers, etc. In some embodiments, a mixture may be tailored to clean a particular type of reagent from a tip surface. In some embodiments a mixture may be tailored to clean a range of reagent types from a tip surface.

In some embodiments, the absorber contains features that inhibit wicking of contaminates or liquids from one region to another. In some embodiments, a wicking inhibitor is applied to at least one region of a sheet, tape, or floss. In some embodiments a wicking inhibitor is induced in a region by one or more of: a pressure, a force, a high temperature treatment, a chemical treatment, an optical treatment, a laser.

In some embodiments the absorber contains features that promote wicking of contaminates or liquids within a region of a sheet, tape, or floss. In some embodiments, such a feature may be applied via mechanical disruption of an inhibitive layer, thermal treatment, optical treatment, plasma treatment, electrical discharge, electret creation, chemical treatment, solvent treatment.

Some embodiments of tip cleaning stations comprise a collection of a clean tape or floss, herein called the ‘source roll.’ Some embodiments of tip cleaning stations further comprise a collection of used tape or floss, herein called the ‘waste roll.’ Some embodiments of these collections may be spindle-rolled, flaked, wound, bobbined, balled, or alternatively disposed.

Some embodiments of the present invention comprise an actuator that can pull a tape or floss. Some embodiments of actuators may comprise a capstan or pinching mechanism. Some embodiments may comprise a reel or roll mechanism. Some embodiments employ a motor or solenoid to actuate the mechanism. Some embodiments comprise at least one mechanical element that allows a motion traverse to actuate the mechanism.

Some embodiments of cleaning stations comprise a source roll, a waste roll having features to facilitate its actuation by a motion stage, a ‘wetting station’ wherein a cleaning solution or solvent is introduced to the floss or tape and the floss or tape is spatially constrained, a ‘take-up interface’ wherein the floss or tape is constrained is spatially constrained, and a cleaning region disposed between the wetting station and take-up interface. Some embodiments comprise a single floss or tape and some embodiments comprise a plurality of flosses or tapes that run substantially parallel or a plurality of flosses that cross each other within the cleaning region.

Some embodiments comprise a ‘liquid doser’ that supplies a dose of cleaning liquid or solvent to the wetting station. Some embodiments of liquid dosers comprise a pump mechanism that can be actuated by motion of a traverse, such as a spring-returned check-valve pump, piston pump, eye-dropper, droplet-on-demand generator or other mechanical pump as known in the art. Some alternative embodiments comprise an electrically actuated pump as known in the art. Some embodiments of dosers may comprise a gas or air gap between the pump exit and wetting station to prevent back contamination of the cleaning solution or mechanisms.

### Tip Cleaning Method

Some embodiments of cleaning stations employ a motion traverse to actuate a ‘cleaning motion’ of a tip relative to a floss or tape that may wipe and abrade the tip on the floss or tape surface.

Some embodiments may comprise a rotation of the tip about its axis combined with motion along the axis of the floss or tape. In some embodiments this motion is combined with motion along the axis of the tip.

Some embodiments of cleaning motions may comprise lowering a tip adjacent to a flow or tape, moving the tip substantially transversely to interfere with the floss or tape, sliding the tip substantially along the axis of the floss or tape in combination with sliding the tip up or down along the axis of the tip so that one side of the tip surface is wiped by the floss or tape. Some embodiments may optionally advance the floss or tape, then perform substantially a mirror image of this motion on the other side of the floss or tape to clean the other side of the tip. Some embodiments may comprise motion back and forth, in a zig-zag motion transverse to or along the axis of the floss or tape. Some embodiments may comprise a circular or elliptical helical motion of the tip relative to the floss or tape.

Some embodiments comprise a plurality of flosses that cross within the cleaning region. The cleaning motion in such an embodiment may comprise lowering the tip between the crossing threads followed by a motion that is substantially along the bisection of the two threads accompanied by a motion up or down along the axis of the tip. In some embodiments this motion terminates with an upward motion that disengages the tip from the flosses. In some embodiments, a substantial mirror image of this motion may be performed starting from the other side of the crossing point. Some embodiments may comprise motion of a zig-zig, helical, or elliptically helical nature.

Some cleaning methods in accordance with embodiments of the present invention may comprise one or more of:
Optionally advancing a floss;
Optionally dosing a floss with a wash liquid;
Optionally advancing a floss and dosing with a second wash liquid;
Advancing the wetted portion of floss to a cleaning zone;
Sliding the tip surface to be cleaned in a pattern across a floss;
Iterating advancing, dosing, and sliding steps, optionally with variations until the tip is clean;
Drying the tip on clean floss.

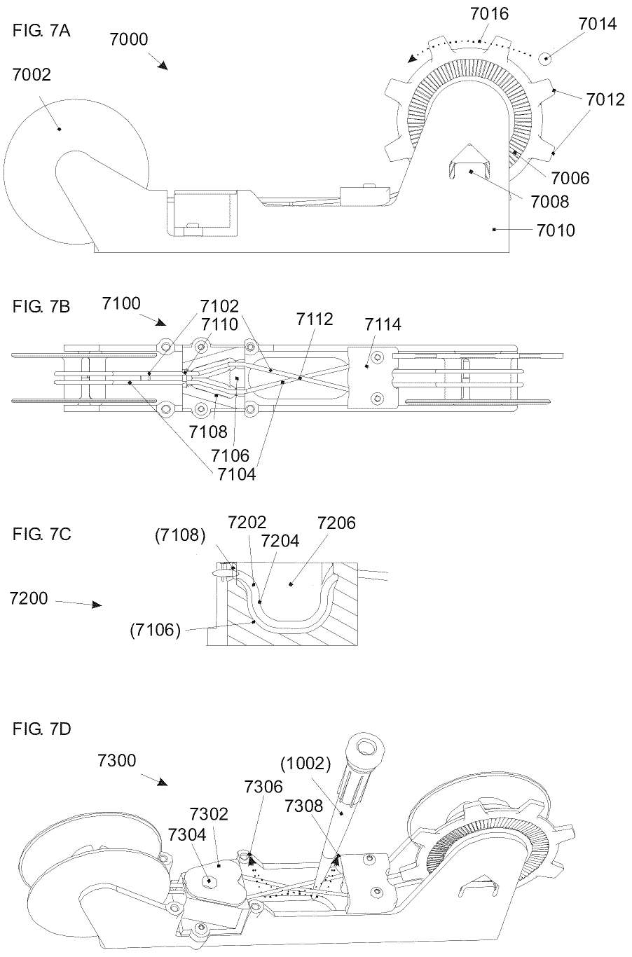

FIG. 7A shows a side view 7000 of a cleaning station embodiment according to some embodiments of the present invention. Element 7002 is a wound-reel embodiment of a source of clean floss. Element 7004 is a wound-reel embodiment of a destination for used floss. Some embodiments of reels 7004 may contain a feature, such as a polarity of ratchets 7006 that engage with a one-way locking or friction enhancing feature 7008 on a frame 7010. In some embodiments, one or more of the source and destination reels are contained in a replaceable cartridge as known in the art. Some embodiments of cartridges may incorporate additional parts of the mechanism, such as a wash liquid tank, dispenser, floss guides, etc.

Some embodiments of cleaning stations employ a motor to rotate drum 7004 to advance the floss. Some embodiments employ motion of the traverse to advance the floss. In embodiment 7000, elements 7012 are teeth of a cog that is actuated by a traverse-mounted feature 7014 via a traverse motion, e.g., 7016.

FIG. 7B is a top view 7100 of a cleaning station embodiment, showing the path of two flosses 7102 and 7104 from source to destination reel. Some embodiments utilize one floss and some embodiments utilize additional flosses. Element 7106 contains one or more sluices 7108 for the floss that facilitate applying a dose of the wash liquid onto floss where it may wick between fibers. One or more slit features 7110 resists wicking of the cleaning fluid back toward the clean roll. In some embodiments the slit comprises a hydrophobic or low-surface energy material. Some embodiments employ an alternative geometry for this purpose. In this embodiment, two flosses slide along each other where they cross at 7112. Element 7114 comprises a second floss guide that may maintain the crossing geometry or other floss geometry to be used in cleaning,

FIG. 7C shows a view 7200 of element 7106 cut parallel to the floss patch through the sluice in accordance with an embodiment. After passing through the slit (7108), the floss path 7202 dips into a trough. Wash fluid is introduced in region 7204. The cavity 7206 is filled with a cap/interface to the liquid dosing system.

FIG. 7D shows an offset view 7300 with the cap/interface 7302 and its liquid inlet 7304 in accordance with an embodiment. In some embodiments of the present invention, the dosing of the liquid is performed via motion of the traverse or pipette tip (1002). In some embodiments, washing of the outer surface of the tip proceeds by a motion trajectory, e.g., 7306 that is substantially aligned with the bisector of the two flosses. In some embodiments, the motion trajectory may be repeated substantially mirrored, e.g., 7308. Some embodiments may employ motion transverse to a floss axis. Some motions may comprise circles, ellipses, loops, helices, etc. to provide for cleaning of all relevant surfaces. Some motions may be repeated on different sides of a floss. Some motions may be repeated after advancing a floss. Some motions may be repeated after dosing a floss with a cleaner. In some embodiments, the cleaner composition may be varied between iterations. In some embodiments, the cleaner composition may follow a gradient, e.g., a linear, exponential, or Gaussian gradient. Gradient cleaning may efficiently clean a complex or unknown sample better than a single composition cleaner.

Some embodiments of cleaners may be arrayed so that different cleaning systems of fibers, surfaces, liquids, and compositions may be applied.

### Normalizer

Some embodiments rely in part on a tip station that ‘normalizes’ a tip's contents. As used herein ‘normalized’ contents may be amenable to reliable processing. Some attributes of normalized contents may be: a high state of mixedness, a substantial lack of internal bubbles, droplets, and secondary menisci, and a substantially known axial position within a tip. Some embodiments of tip stations may perform a partial normalization.

### Membrane/Barrier-Based

Some embodiments improve normalization within a tip by drawing liquid up to a barrier that passes gases but not liquid, such as a barrier filter. Some embodiments perform normalization by passing the tip contents once or multiply through one or more membranes or meshes within a tip that selectively retains a liquid or a gas. Some mesh/membrane embodiments comprise a surface having one or more of a low surface energy, hydrophobicity, hydrophilicity.

### Gravity

Some embodiments employ the flow controller or a tip station to draw a partial vacuum to expand bubbles so they can rise under gravity. Some embodiments employ centrifugation to separate gas and liquid phases.

### Centrifugation

Some embodiments of centrifugal tip stations according to the present invention comprise a station that bends a tip either during the process of insertion into the rotating head of the station or at a later stage. Some embodiments of centrifugal tip stations comprise a rotating head that can change geometry so the tip can be inserted and removed without a bend, but centrifugation performed with a bent geometry in such a way that liquid pools under centrifugation at an interior point in the tip. Some embodiments employ centrifugal force to produce a bend in the tip. Some embodiments comprise an interference such that a tip buckles under axial pressure into a curved shape for centrifugation.

Some alternative embodiments of centrifugal tip stations comprise a station that collects liquid at the actuator port or barrier filter or reagent port of a tip. Some such embodiments may require a tip plug at the reagent port or tip cap at the actuator port to eliminate leakage.

### Vortexer/Vibration

Some embodiments of the present invention comprise a tip station wherein a tip experiences a linear or circularly polarized transverse vibration. In some embodiments vibration is driven substantially near the tip reagent port such that the tip experiences a high or maximal vibrational acceleration. Some embodiments apply vibration at an interior point or at the actuator port side of the pipette tip. Some embodiments apply vibration forcing at a plurality of positions.

In some embodiments, this vibration may produce one or more fluid transport effects. Vibration and flexure of menisci produce a flow that can exhibit turbulent mixing at substantially lower Reynolds numbers than would be expected for a single-phase flow, so the vortexer/vibration stage may be an excellent fast mixer and be used to resuspend particles, beads, macromolecules, etc.

Vibration, coupled with the tapering geometry of the tip may produce transport up the pipette tip via unbalanced normal forces.

Vibration amplitude gradients may produce a second-order force that drives fluid away from regions of large vibration intensity, since the overall kinetic energy of a liquid/gas mixture is minimized when the dense liquid undergoes low-intensity vibrations compared to those of the gasses. Such transport may be engineered by: tip design, design of one or more rigid/semirigid mounts, and design of one or more vibration dampers within the vibration station.

### Vibration Dampers

Some embodiments of such vibration dampers may comprise a rigid, elastic, semi-compliant, viscoelastic, or non-Newtonian object shaped to interfere with a component of the vibrational motion of the pipette tip. Some dampers may extend annularly around the tip. Some dampers contact the tip asymmetrically. An asymmetric damper may be engineered produce a variation of circular, elliptical, and linear vibration polarization and amplitude along the axis of the tip. Some embodiments of dampers comprise a rubber piece between 0.2 and 5 mm thick, preferably 0.5 to 4 mm, positioned to interfere with the static (non-vibrating) tip by −5 mm to 5 mm, preferably −2 to 2 mm on one edge, located roughly at the top of the desired fluid plug level. Some embodiments may provide for moving a damper as needed during run time to accommodate different liquids and volumes. Some embodiments may comprise a plurality of dampers disposed at different heights from the tip bottom, located at different positions such that the damper that engages with the tip can be selected by offsetting the tip mount in the direction of the desired damper. Some embodiments comprise a helically disposed damper whose engagement can be continuously adjusted by offsetting the tip mount.

Some vortexer/vibration stage embodiments may employ run-time optimization of vibration amplitude, frequency, ramp up, ramp down, degree of damping, and flow control. The degree of damping may be adjusted in some embodiments by moving the tip mount to increase or decrease an interference with a damping element.

A circularly polarized vibration may set up a circumferential rotation of the fluid. Above a threshold rate, the circumferential rotation may produce a fluid profile having a gas-filled hollow core. The presence of this core may allow liquid segments to merge at relatively low vibration levels. The collapse of this core may be controlled by controlling the damping or ramp-down rate of the vibration to allow the collapse of the core to proceed from one end of the annulus to the other without re-entrapping gas pockets.

Some embodiments of vibration producers in accordance with the present invention comprise one or more of: a motor, a solenoid, an ultrasonic transducer, a voice coil, an acoustic horn. Circularly or elliptically polarized vibrations can be produced by a plurality of synchronized linear vibration sources. Some embodiments produce circularly polarized vibrations via a motor-driven stage having an eccentric tip interface.

The eccentric tip interface in some embodiments may further comprise a tapered lead-in that guides the tip to the center. Such an arrangement may have the advantage of bending the tip end into the interface without knowledge of the rotation angle of the motor shaft. A further benefit may be that the tip may be inserted while the motor and eccentric tip is in motion, allowing the motor to be started before the tip is inserted, which may prevent stall or excessive starting current.

Some embodiments further comprise a ball bearing or bushing between the tip and the eccentric interface. Some embodiments comprise interfacing the eccentric stage to a tip having an end plug. Some such embodiments may protect the tip from abrasion during insertion into the stage. Some such embodiments may further protect against the potential for contamination by aerosolization of the tip contents.

A method for normalization of the contents of a tip may comprise one or more of:
Pre-positioning the pipette contents via a flow controller;
Starting rotation of a motor;
Engaging a bare or plugged tip into a stationary vibrational drive interface;
Engaging a bare or plugged tip into a moving vibrational drive interface;
Engaging a bare or plugged tip into a rotating vibrational drive interface having a tapered lead-in;
Ramping up the rotation speed of a motor;
Dwelling at a rotation speed;
Ramping down the rotation speed of a motor;
Dwelling at a second rotation speed;
Moving a damper element;
Moving the tip transversely;
Moving the fluid in the tip axially using a flow controller;
Stopping rotation of a motor;
Taking a reading of an optical transmission, absorption, reflection, or scattering sensor;
Taking a reading of a capacitance, resistance, ultrasonic, or other sensor;
Adjusting one or more of: motor speed or applied Voltage, amplitude, transverse position, axial flow rate, dwell time, repetition count based on a sensor reading;
Adjusting one or more of: motor speed or applied Voltage, amplitude, transverse position, axial flow rate, dwell time, repetition count based the known or inferred physical properties such as viscosity, surface tension, hydrophilicity, hydrophobicity, of the tip contents;
Repeating one or more above steps.

In some embodiments it may be preferred not to allow the fluid to come into contact with a barrier filter. In some such embodiments, a lower initial speed ramp-up rate and maximum speed may be desirable. In some embodiments the ramp-down rate may be designed to allow time for an annular plug of fluid to collapse to a solid plug substantially without capturing gas bubbles.

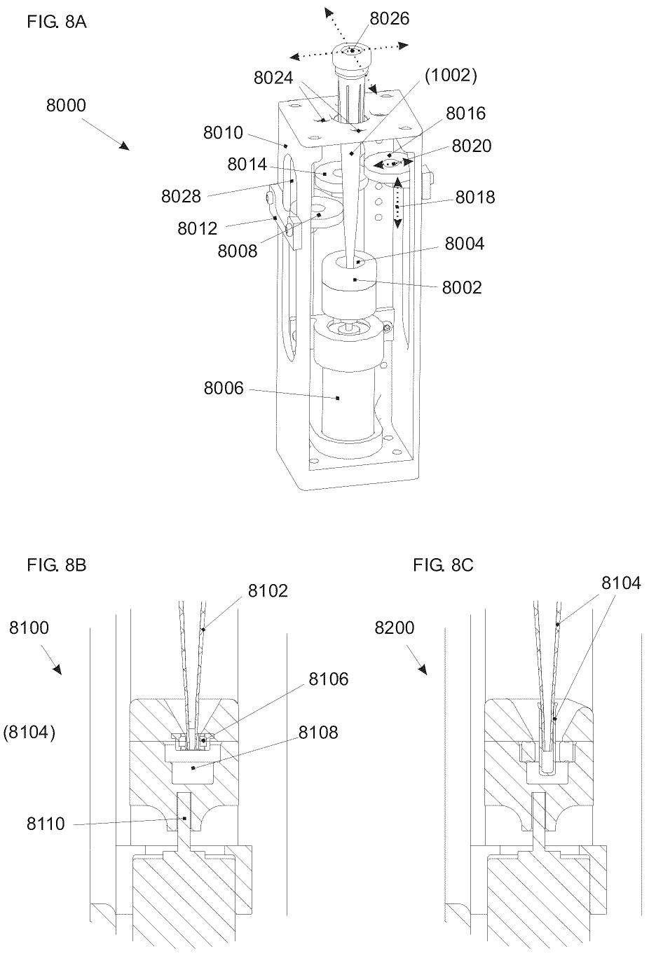

FIG. 8A shows an embodiment 8000 of a vortexer/normalizer according to some embodiments of the present invention. Element 8002 is a rotor having a tapered lead-in surface 8004 that guides the tip 1002 into an eccentric opening. Element 8006 is an electric motor. Element 8008 is a first damper connected to the frame 8010 by a mount 8012. Element 8014 is a second damper connected directly or indirectly to the frame. Element 8016 is a third damper. Some embodiments comprise only one damper. Some embodiments comprise a mount that provides for actuation or adjustment 8018 of the damper location substantially along the axis of the tip. Some mount embodiments provide for radial actuation or adjustment 8020 of the damper. Some embodiments provide for adjustment of the engagement of the tip with the damper via transverse motion of the tip or stage 8022. Some embodiments comprise one or more alignment features 8024 that mate with a pin (e.g., 5208) in the tip-mount traverse. Some embodiments disengage the tip before vortexing. Some embodiments perform vortexing with the tip partially or fully engaged on the tip-mount traverse. Some embodiments employ a transverse offset or tip displacement to select a damper and modulate the magnitude of damping. In some embodiments element 8028 comprises one or more slots or viewports for an optical sensor. Some embodiments use the output of an optical sensor for feedback in controlling a motor.

FIG. 8B shows a cut-away section 8100 of an embodiment of a vortexer rotor that accepts a bare tip 8102. In this embodiment, the tapering surface 8104 guides the tip into a bearing 8106 seated in a cavity 8108 that is eccentrically offset from the motor shaft 8110.

FIG. 8C shows a cut-away section 8200 of an embodiment of a vortexer rotor that accepts a plugged tip 8014. This arrangement may have the advantage of containing any aerosolized particles, preventing chafing and abrasion of the tip during insertion, eliminating a cross-contamination pathway, etc.

### Vibrationally-Induced Axial Flow and Mixing

Some embodiments of processing stages may employ a vibrationally induced circumferential flow to drive a secondary flow via interior features, such as ridges, dips, helices or bends of the tip. For example, opposed helices could work to drive plugs of fluid together or apart depending on the rotation sense.

Some embodiments of vibrational stages may employ vibrationally induced circumferential flow to drive one or more of: mixing, degassing, removing bubbles, an axial channel flow from one port of a flexible tube to a second port of a flexible tube. Some embodiments may produce the flow via one or more helically disposed ridges or grooves on the inner surface of the tube. Some embodiments may distort the inner surface of the tube by external forces to produce a helical, varicose, or ratcheting internal geometry. Some embodiments may superimpose a vibrating force on a static shape-producing force to induce axial motion with a channel. Some embodiments may externally induce a travelling wave pattern on the inner surface of a channel to induce the motion.

### Thermocycler/Reactor Station

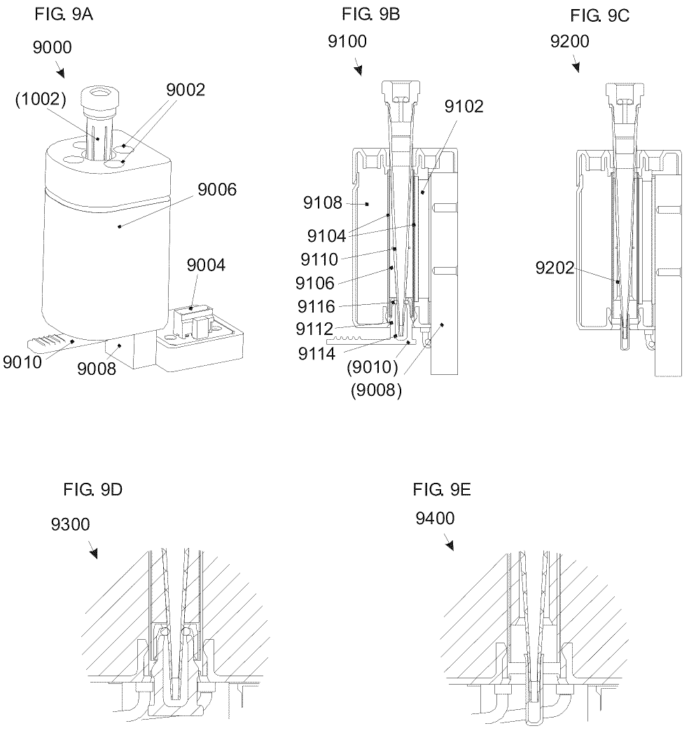

Some embodiments of the present invention further comprise a thermally controlled reactor station. FIG. 9A shows a view 9000 of a thermocycler embodiment holding a tip (1002). Some embodiments comprise elements 9002 to facilitate alignment with a tip-mount traverse to allow a tip to be deposited and picked up from the thermocycler. Some embodiments comprise thermal control and feedback electronics 9005, including one or more of: a temperature sensor, a cold-junction reference, an inductive PWM filter, a semiconductor switch, a thermocouple cold junction, a thermistor, a resistor, a diode, a capacitor a microcontroller. Some embodiments comprise a shell 9006. Some embodiments comprise a heat sink 9008. Some embodiments, especially embodiments that do not employ a tip plug, further comprise element 9010, a removable plug that produces a seal to the reagent port of the tip when the tip is inserted into the thermocycler.

FIG. 9B shows a side view 9100 of a thermocycler embodiment. This embodiment is driven via a Peltier device 9102 in thermal communication with a heat sink (9008) and heat spreader 9104. Some embodiments of heat spreaders comprise a thin-walled tube or conformally wound foil on a thin plate or foil that is bonded or mated to a Peltier surface via a thermally conductive adhesive or paste. Some embodiments comprise a copper tube soldered or braised to a plate. Some embodiments further comprise a thermally conductive heat coupler 9106 between the heat spreader and tip. Some alternative embodiments comprise a heat spreader that conforms to the shape of the seated tip.

Some embodiments establish the compliance of the heat coupler by one or more of: material selection, patterning features into the heat coupler, using a putty-consistency heat coupler. Some embodiments of heat spreaders are thermal interface materials as known in the art, especially, castable, two-part rubber-based filled elastomers.

Some embodiments of thermocyclers comprise an insulator 9108. Some embodiments of insulators are closed-cell foams, such as a polyurethane foam, an aerogel, or conventional insulator as known in the art.

Some embodiments comprise a thermal sensor 9110 proximal to the tip. Some embodiments comprise a thermocouple junction wrapped in a fine “magnet wire” or the like around a tip cavity mold prior to casting of the heat spreader.

In embodiment 9100, a removable tip seal (9010) is inserted into an opening in the shell (9006) and held in place via ‘bayonet’ mounting features 9112. When a tip is inserted the reagent port passes without contacting any external surface into a cavity 9114. A ring seal at 9116 minimizes the loss of tip contents during thermal cycling and seals the end of the tip against pressure generated by temperature changes and gravity. If the tip is unmounted during a reaction, excess pressure may be vented through the tip cap. Having a barrier filter that is outside the heat zone may discourage evaporative loss of sample. Some embodiments may further comprise a septum, valve, or seal at the actuation port to prevent evaporation or other unwanted transport.

Some embodiments of thermocyclers do not have element 9010. Some rely on a tip having a temporary seal in place. Some rely on having the tip connected to a pressure regulator or flow controller.

FIG. 9C contains a view 9200 of an embodiment of thermocycler intended for use with plugged pipette tips. In some embodiments, the bore of the thermal interface material 9202 may need to be widened to allow passage of the tip into and out of the station.

FIG. 9D shows a cut-away section 9300 around the removable tip seal of 9100 and FIG. 9E shows a cut-away section 9400 around the tip plug of 9200.

Some embodiments of thermocyclers according to the present invention may provide tip temperatures between −10° C. and 150° C. Some embodiments of thermocyclers may be used for thermal fractionation, crystallization, phase-change processing, incubation, polymerase chain reaction, in-vitro transcription, labeling, capping, and other physical, chemical, biological, and biochemical processing as known in the art.

### Magnetic Separator Station

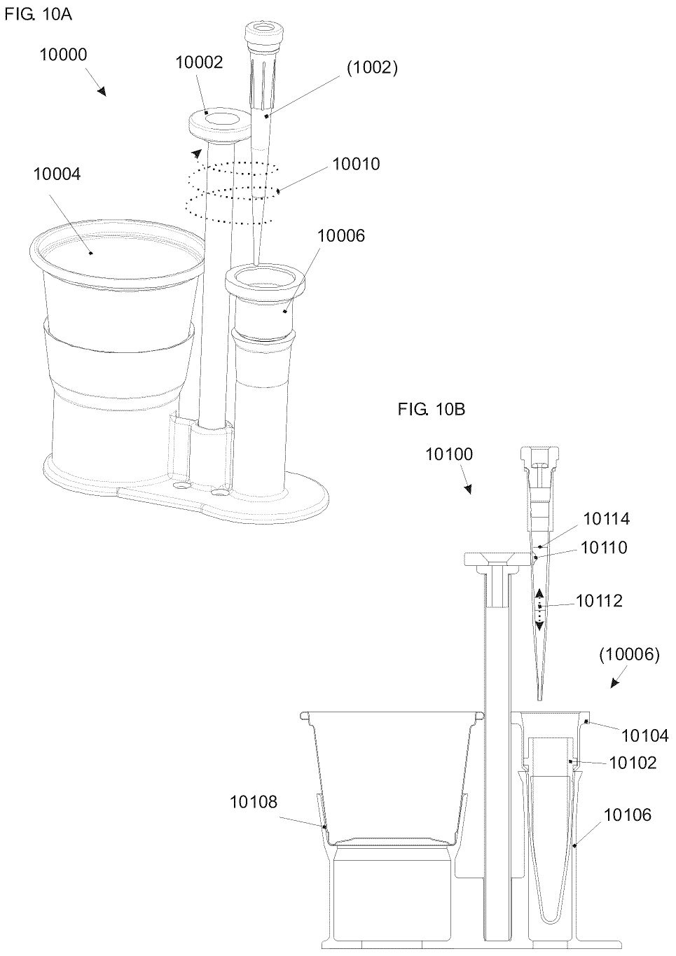

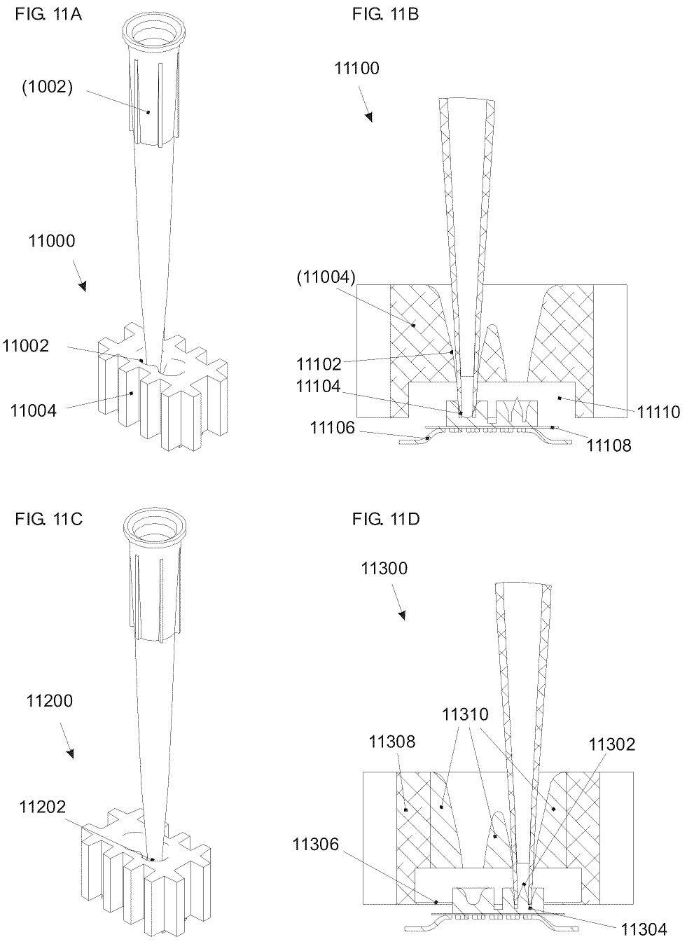

Some embodiments of the present invention further comprise a magnetic separator station wherein a tip's contents are moved relative to a non-uniform magnetic field via one or more of: motion of a tip induced by a motion stage, motion of the contents of the tip induced by a flow controller, motion of a magnet or modulation of a field. FIG. 10A shows an embodiment 10000 of a magnetic separator wherein a tip (1002) is positioned proximate to a magnet 10002. The station comprises a waste port or container 10004 and a vial assembly 10006. The tip may be moved up and down or helically (10010) to collect particles efficiently. When the particles are collected on a surface, the tip may be moved over the waste port or the vial and the non-trapped contents eluted.

FIG. 10B shows a cut-away view 10100 of the magnetic separation station embodiment. The vial assembly (10006) comprises a vial 10102 and vial interface 10104. Element 10106 is a vial mount and 10108 is a waste cup mount. In some embodiments the vial interface facilitates inserting and removing a vial from a deep recess in a freezer or ultra-freezer module.

Element 10110 is a plug of particles collected on the inner surface of the tip. During elution and collection of the particles, the contents of the tip may be moved axially (10112) by the flow controller.

This may reduce magnetic particle collection times, improve collection efficiency, overcome adverse effects of trapped bubbles, etc. Once the top meniscus 10114 is lowered past the plug of particles, surface tension may retain the plug of particles to the tip surface along with residual liquid. This residual liquid may contain unwanted components that may need to be diluted by repeating an infusion/resuspension/reseparation procedure until a desired purity is reached.

A method for magnetic separation according to the present invention is one or more of:
Bind a desired analyte/product to magnetic beads within a tip;
Move the tip to the magnet;
Move the tip relative to the magnet;
Move the tip contents relative to the magnet;
Wait until substantially all particles are trapped densely on the tip surface;
Position the tip over the waste port;
Elute the un-trapped liquid contents to the waste port. There will be residual liquid immediately surrounding the particles;
Optionally clean the tip as disclosed herein;
Infuse rinsing liquid, e.g., water, ethanol, etc. as known in the art;
Optionally wait for diffusion of contaminants from the particle plug into the rinse liquid;
Optionally clean the tip;
Optionally plug the tip;
Optionally vortex/normalize the plug to substantially resuspend the particles and dilute contaminants with rinsing liquid;
Optionally unplug the tip;
Repeat the magnetic separation steps and elution above until the remaining particles and solution are sufficiently pure;
Infuse a carrier liquid for the analyte/product into the tip containing the purified particles;
Optionally normalize and resuspend the particles;
Optionally plug the pipette tip;
Engage the tip in the thermocycler station and pulse the temperature to denature the analyte/product from the magnetic beads;
Optionally unplug the pipette tip;
Repeat the steps above to re-collect the magnetic particles to the tip surface;
Move the tip over the product vial and elute.

### Method for Loading a Plurality of Fluid Agents into a Mobile Microfluidic Device

Some embodiments of the present invention comprise a method containing one or more of the following steps to produce a normalized plug containing a mixture of a plurality of liquids.
Position a tip at the site of a first reagent buffer;
Use a flow controller as disclosed herein to perform the infusions 4000 and 4100 on a first reagent and buffer, respectively;
Perform a tip cleaning method as disclosed herein;
Position a tip at the site of a second reagent buffer;
Use a flow controller to perform the infusions 4200 and 4300 on a second reagent and

buffer, respectively;
Alternatively use a flow controller to perform the infusions 4200 and 4400 on a second reagent and buffer, respectively;
Optionally perform a tip cleaning method as disclosed herein;
Optionally repeat a sequence of infusions 4200 and 4300 or 4200 and 4400 on additional reagents and apply the tip cleaning method;
Optionally perform a tip plugging method as disclosed herein;
Optionally perform a tip sealing method as disclosed herein;
Position a tip at the site of a vortexer/normalizer apparatus as disclosed herein;
Perform a vortexing/normalizing method as disclosed herein;
Optionally perform a tip un-plugging method as disclosed herein;
Optionally perform a tip un-sealing method as disclosed herein;
Move the tip containing the mixed reagents to a processing station.

### Tip Sealer/Un-Sealer Station

Some embodiments of the present invention comprise a station wherein a tip may be sealed and a station where a tip may be unsealed. In some embodiments, these stations may be combined into a single station having shared components, but this arrangement is not intended to be limiting. As used herein, ‘sealing’ and ‘unsealing’ may refer to a process of adding or moving material to block fluid transport and removing or moving material to enable fluid transport, respectively. In contrast, a plug as used herein is characterized as a discrete physical body, however, the distinction is purely semantic and not intended to be limiting. A tip may be sealed by application of a phase-change material, such as a wax. In some embodiments, a tip may be impulse heat sealed closed and impulse heat re-opened. In some embodiments re-opening may employ a different mechanism than heating, e.g., abrasion, cutting, drilling etc.

FIG. 11A shows an embodiment 11000 of a tip sealer/un-sealer having a tip (1002) inserted into a sealing port 11002 in a housing 11004. Some embodiments of housings 11004 may comprise a heat sink, comprising a thermally conductive material and may further comprise features such as a cooling fin. Other embodiments of housings 11004 may comprise a temperature-resistant thermal insulator. An objective of the housing may be to localize heat addition within the station to the immediate region of the seal.

FIG. 11B shows a cut-away view 11100 of the interior of the station. Element 11102 is a tapered surface that may precisely align a tip with a mandrel 11104 that bears a cavity 11104 shaped to deform a thermally softened tip into a sealed configuration. Element 11106 is a heat source such as an electric resistor in a circuit. Some embodiments further comprise a thermal sensor element and employ temperature control feedback as known in the art. Element 11108 is a high-temperature insulating film, such as a mica film. Element 11100 may be an open cavity or may contain an insulator. An objective of the design of the system may be to localize high heat to a minimal-thermal mass mandrel and isolated sealing region of a tip. In some embodiments the tip is removed from the mandrel hot. In some embodiments, the tip is removed a after a cooling interval.

FIG. 11C shows a view 11200 of the station having a tip in the unsealing position 11202. FIG. 11D is a cut-away view of the station. The tip end is located in a mandrel comprising a piercing point 11302 and a shaping cavity 11304. In some embodiments the tip is removed from this station hot. In some other embodiments the tip is removed from this station after a cooling interval. In the embodiment shown, there is at least one thermal bridge object 11306 between the mandrel block and heat sink 11308 to increase the rate of cooling of the mandrel. Some embodiments break the housing into a heat-sink 11308 and a substantially insulating alignment guide 11310.

### Tip Plugger/Unplugger/Plug Decontamination Station

As used herein, a tip is ‘plugged’ or ‘unplugged’ by physically inserting and removing a body inside or around the tip. Some embodiments of plugs may be used once to avoid cross contamination. Some embodiments of plugs may be decontaminated. Some means of decontamination comprise chemical decontamination, washing, cleaning, auto-claving, pyrolysis, etc., and combinations thereof as known in the art.

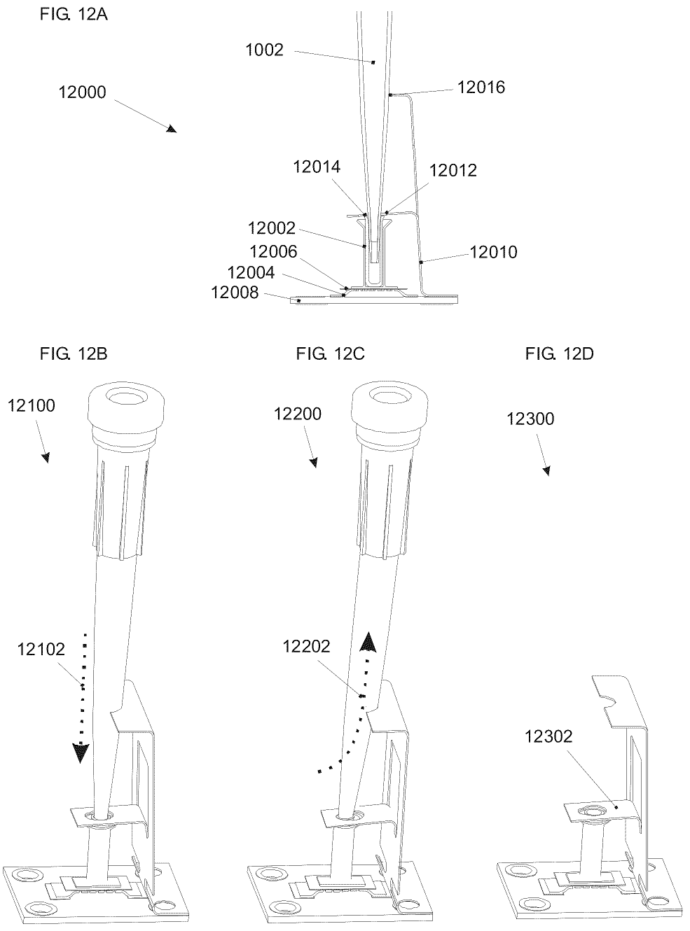

FIG. 12 Shows a plug station embodiment 12000 comprising a repository for a plug 12002. In this embodiment, this repository is also a high-temperature-stable, thermally conductive heat spreader. Element 12004 is a switchable or modulatable heat source, e.g., an electrical resistor in a circuit. Element 12006 may comprise a high-temperature electrical insulator film, e.g., a mica film and element 12008 is a high-temperature stable base mount such as a printed circuit board or insulator board. Some embodiments further comprise a heat sensor or a temperature-actuated switch.

Element 12010 is a lever/spring that is switchable between a plug-unretained and plug-retained state. In this embodiment, this switching involves moving a slot between a wide region 12012 and narrow diameter region 12014 through which a plug cannot pass. This motion may be activated via a side force at position 12016, e.g., via a side force from a tip 1002, a side force from a traverse-mounted object, etc. In some alternative embodiments, an alternative mechanism may be employed to produce a switchable retained/un-retained state. In some embodiments a magnetic, an electromagnetic, an electrostrictive, magnetostrictive, hydraulic, pneumatic, etc. actuator may be used actively to switch between a retained and unretained state, as known in the art.

FIG. 12B shows a view 12100 of a plug insertion tip motion 12102. FIG. 12C shows a view 12200 of a plug deposition tip motion 12202. The initial lateral motion activates the retention feature and the upward motion pulls the plug off the tip.

FIG. 12D shows a view 12300 of the plug in the station. If desired, the plug can by pyrolytically or otherwise thermally denatured by applying power to a heat source. In some embodiments the lever/spring 12010 may be designed to spring to a plug-closed position, e.g., 12302 when the tip is retracted. In some embodiments, this position may be used to retain any boiling liquid or contaminants from becoming aerosolized by the heating process. Some embodiments may further provide convection or a duct to vent pyrolysis or evaporation products, etc., from passing to other stations.

### Vial Interface

In some embodiments, the mobile microfluidic element may comprise a vial. In some embodiments a vial may further comprise a storage cap as known in the art. In some embodiments, a vial may further comprise a transportation interface. In some embodiments, a vial may further comprise an insulating cap. An objective of a transportation interface for a vial may be to allow a vial to be positioned using a traverse from a one mount to another, including mounts within stages that have a deep recess, e.g., a freezer or ultra-freezer module.

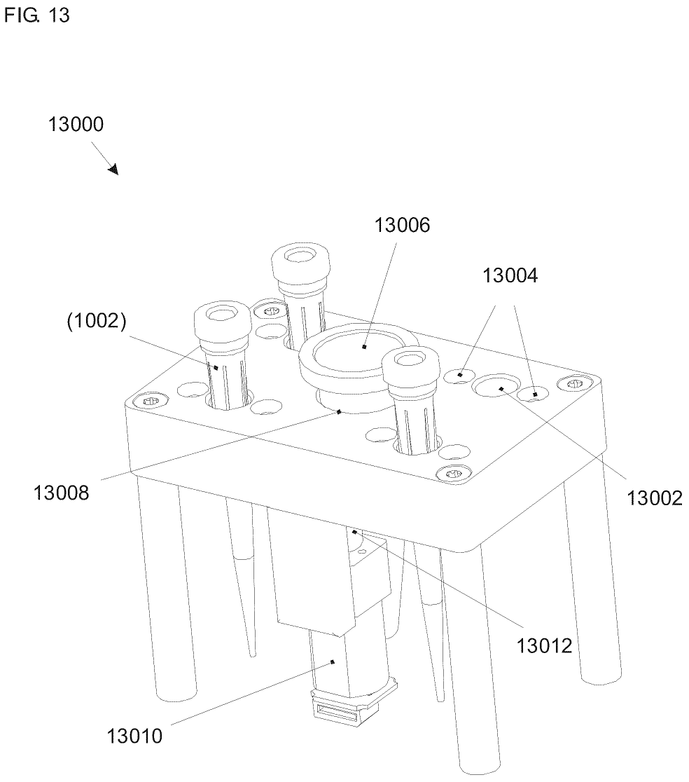

FIG. 13 shows a view 13000 of a workstation for tip, vial, capping, and storage operations. Element 13002 is a cavity shaped to support a tip 1002. Elements 13004 are alignment/bearing features that may interact with an object on the tip mount traverse. Element 13006 is a vial transport assembly in support cavity 13008. Some embodiments of workstations further comprise a motor such as a gearmotor 13010 that can rotate a vial or tip, e.g., by turning a roller or sprocket 13012, satellite rollers etc. as known in the art. Some embodiments employ at least one tooth that engages with a mating feature on the outer periphery of the vial or tip. Some embodiments use this motion to apply and remove a twist-on cap. Some embodiments further comprise locations for placing insulating caps, pipette caps, pipette plugs, twist-on caps, and other system components having breakable connections etc.

### Freezer

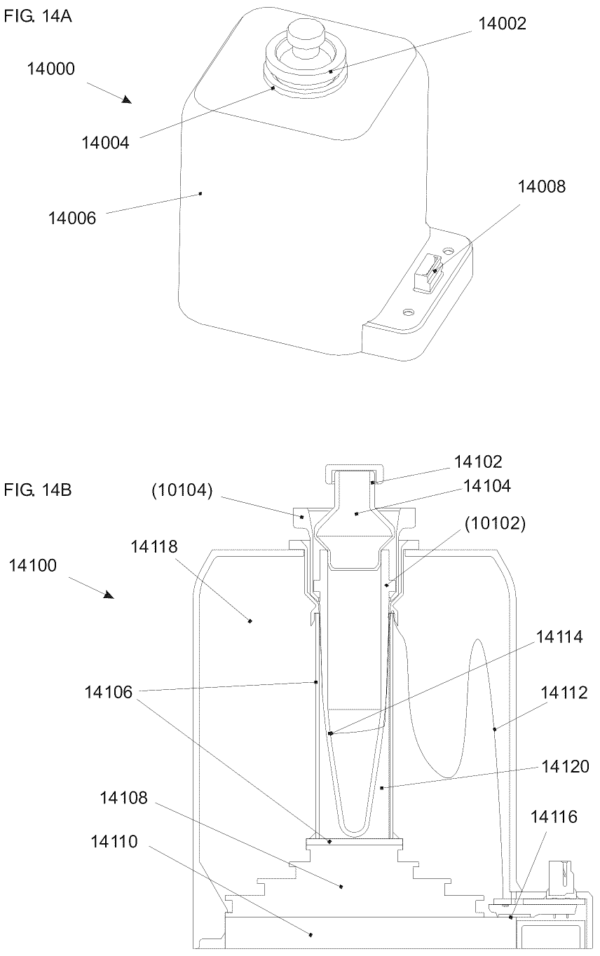

Some embodiments of the present invention comprise a freezer or ultra-freezer apparatus. FIG. 14A shows an embodiment 14000 of an ultra-freezer in which a vial transport assembly 14002 has been inserted. Element 14004 is a lead-in section that may also direct condensate away from the vial port. Element 14006 is a condensate-shedding shell. Element 14008 is an electrical interface.

FIG. 14B is a cut away view 14100 that shows the interior structures. Element 14102 is an insulating vial cap shell filled with an insulating material 14104, such as a polyurethane foam, aerogel, etc. The vial transport interface 10104 provides for inserting and removing a vial (10102) comparatively deep into the freezer recess. This recessed position may reduce unwanted heat transport. Element 14106 is a heat spreader comprising a flat plate and a cylindrical tube. In some embodiments the heat spreader comprises a foil or tube that conforms substantially to the outside shape of the vial. Element 14108 is a multiple-stage Peltier cooler as known in the art. Element 14110 is a heat sink/cold-plate interface. Element 14112 is a thermocouple wire that terminates in a junction 14114 that is proximal to the vial outer surface. Element 14116 is a ‘cold junction’ compensation sensor in thermal communication with the heat sink. Element 14118 is a high-performance thermal insulator such as an aerogel or polyurethane foam as known in the art.

In some embodiments, element 14120 is a cast thermal-interface material as known in the art. In some embodiments this material is compliant.

A fragile-sample thawing method of the present invention may comprise one or more of:
Manually inserting a vial transport assembly into the freezer;
Inserting a vial transport assembly into the freezer using the traverse;
Cooling the vial to a frozen state and maintaining a frozen temperature, such as a temperature in the range −80° C. to 0° C.;
Raising the vial temperature to an unfrozen temperature, such as 4° C. to 20° C.;
Monitoring the outer vial temperature for inflection points that evidence the start and termination of a phase change;
Ramping the outer vial temperature to maintain a lower unfrozen temperature, such as 0° C. to 10° C. when the vial contents are substantially melted to avoid over-heating a fragile sample;
Shaking, vortexing, or ultrasonically mixing the contents of the freezer in place;
Transporting the vial to a vortexing, shaking, or ultrasonic mixing station to mix and resuspend solutes;
Drawing a thawed sample from the vial;
Transporting the vial back to the freezer;
Refreezing the vial contents;

A freezing method of the present invention may comprise one or more of:
Eluting a product into a vial in a transport assembly;
Transporting a vial to a capping station and capping the vial;
Moving the transport assembly to a freezer module and freezing the vial and its contents.

What is claimed is:

1. An apparatus comprising a motorized traverse, a flow controller, a tip-mount traverse, and a tip, further comprising a motion of a tip past an influencer.

2. The apparatus of claim 1 wherein the influencer is a non-uniform magnetic field.

3. The apparatus of claim 1 wherein the influencer is an absorbent material.

4. The apparatus of claim 1 wherein the influencer is a thermal interface material in communication with a thermal source.

5. The apparatus of claim 4 wherein the thermal source is a Peltier module.

6. An apparatus comprising a motorized traverse, flow controller, a tip mount traverse, and a tip further comprising a motion past an actuatee.

7. The apparatus of claim 6 wherein the actuatee is the tip-mount traverse.

8. The apparatus of claim 6 wherein the actuatee is a plug retainer in a station that applies and removes a tip plug.

9. An apparatus comprising a floss, a floss-advancing reel, a floss wetter, and a tip cleaning region.

10. The apparatus of claim 9 further comprising a traverse motion profile that wipes the surface of the tip across a floss.

11. An apparatus comprising a motor, a rotor having an eccentric bearing hole and taper that leads to the bearing hole, and a vibration damping element that acts on a surface region of a tip inserted into the eccentric hole.
